(19) United States
(12) Patent Application Publication
(10) Pub. No.: US 2014/0121869 A1
(43) Pub. Date: May 1, 2014

(54) BATTERY COOLING CONTROL SYSTEM AND METHOD FOR VEHICLE

(71) Applicants: HYUNDAI MOTOR COMPANY, Seoul (KR); KIA MOTORS CORPORATION, Seoul (KR)

(72) Inventors: Gun Goo Lee, Suwon (KR); Hae Kyu Lim, Bucheon (KR); Do Sung Hwang, Gunpo (KR)

(73) Assignees: KIA MOTORS CORPORATION, Seoul (KR); HYUNDAI MOTOR COMPANY, Seoul (KR)

(21) Appl. No.: 13/693,670

(22) Filed: Dec. 4, 2012

(30) Foreign Application Priority Data
Oct. 26, 2012 (KR) 10-2012-0120002

(51) Int. Cl. B60L 11/18; G05D 23/19

(52) U.S. Cl. CPC B60L 11/1874; G05D 23/19
USPC 701/22; 700/300

(57) ABSTRACT

Disclosed is a cooling control system and method for battery packs located in different locations in a vehicle. In particular, a controller determines whether the maximum temperatures of a plurality of battery packs disposed in different locations are within the reference maximum temperature and whether the temperature differences of battery cells in each of the battery packs is within the reference temperature difference value. When the maximum temperature is less than or equal to the reference maximum temperature and the temperature difference between battery cells in each of the battery packs is within the reference temperature difference value, the controller determines whether the temperature differences in all the battery packs are within the reference temperature difference value. Then when each of the temperature differences in all the battery packs are over the reference temperature difference value, an output of a cooling unit provided to cool that battery pack is changed.

### CROSS-REFERENCE TO RELATED APPLICATION

This application claims under 35 U.S.C. §119(a) the benefit of Korean Patent Application No. 10-2012-0120002 filed Oct. 26, 2012 the entire contents of which are incorporated herein by reference.

### BACKGROUND

(a) Technical Field

The present invention relates to a control system and method for cooling a battery system of a vehicle, and more particularly, to a technology for cooling one or more battery to packs separately arranged in difference spaces in a vehicle.

(b) Background Art

Recently, automotive manufactures have begun to mount separate battery packs in different locations in a vehicle such as under a floor panel and in the trunk , rather than mounting these battery packs as a single unit in a single location. Typically this configuration is used with for high-voltage batteries that are mounted in environmental-friendly vehicles which have becoming increasingly popular due to their decreased energy consumption.

However, when separate battery packs are mounted in different locations in a vehicle, as described above, some battery packs may deteriorate faster than others due to different operating environments. As a result, cell balancing often occurs in the battery packs which deteriorate the performance of the entire battery system.

The description provided above as a related art of the present invention is just to aide in understanding the background of the present invention and should not be construed as being included in the related art known by those skilled in the art.

### SUMMARY OF THE DISCLOSURE

The present invention has been made in an effort to solve the above-described problems associated with prior art and it is an object to provide a control system and method for cooling a battery system of a vehicle which minimizes the number of times cell balancing occurs by appropriately controlling the temperature of a battery system including battery packs mounted in different locations in the vehicle. As a result, the present invention improves the performance and durability of the battery, and prevents the performance of the vehicle from deteriorating.

In order to achieve the above object, the present invention provides a control system and method for cooling a battery system of a vehicle, which includes: determining whether the maximum temperatures of a plurality of battery packs disposed in different spaces less than or equal to a reference maximum temperature value and whether the temperature difference between battery cells in each of the battery packs is within a reference temperature difference value. In response to the maximum temperature of the battery pack being less than or equal to the reference maximum temperature and the temperature difference between battery cells in each of the battery packs being within the reference temperature difference value, determining whether each of the temperature differences in all the battery packs are within the reference temperature difference value, ; and in response to determining that each of the temperature differences in all the battery packs is over the reference temperature difference value, changing an output from a cooling unit provided to cool the battery packs.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram illustrating the configuration of an example of a battery system for a vehicle which is separately mounted in different locations and where the present invention can be applied; and

FIG. 2 is a flowchart illustrating an embodiment of a control system and method for cooling a battery system of a vehicle according to an exemplary embodiment of the present invention.

It should be understood that the appended drawings are not necessarily to scale, presenting a somewhat simplified representation of various preferred features illustrative of the basic principles of the invention. The specific design features of the present invention as to disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

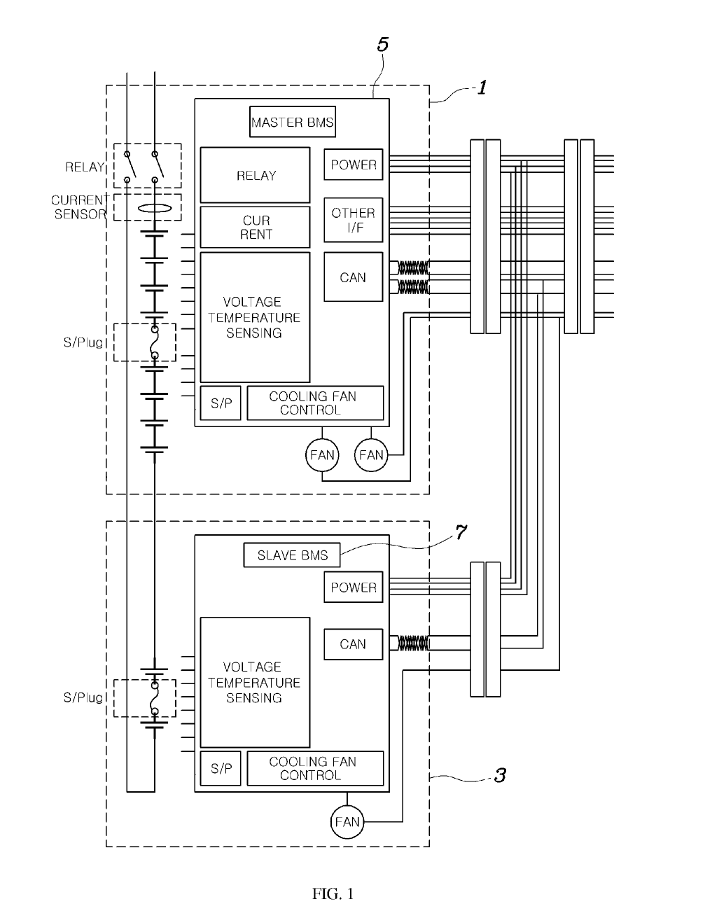

FIG. 1 is a diagram illustrating the configuration of a battery system in which the present invention can be applied, in which a battery pack of the battery system is composed of at least two packs, i.e., a master pack 1 and a slave pack 3. The master pack 1 includes a first/master battery management system (BMS) 5 and the slave pack 3 includes a second/slave BMS 7 such that the battery packs can each be electronically managed.

The master BMS 5 and the slave BMS 7 may be embodied as controllers each including a processor and memory for executing the below described process. The processes may be stored on a memory or any other non-transitory computer readable media and may be executed by the processor accordingly.

More specifically, the master BMS 5 controls a cooling unit, e.g., at least one cooling fan, for the master pack 1 by monitoring the entire battery temperature of the master pack 1 and the slave pack 3, determining the stage/operating level of cooling fans (e.g., in the case of a cooling fan, how fast the cooling fan rotates) at the master pack 1 and the slave pack 3, respectively, and also provides an instruction regarding the operating level of at least one cooling fan at the slave pack 3 to the slave BMS 7. The slave BMS 7 is configured to control at least one cooling fan of the slave pack 3 by receiving instruction from the master BMS 5 and transmits a sensed/detected value, such as the temperature of the slave pack 3, to the master BMS 5.

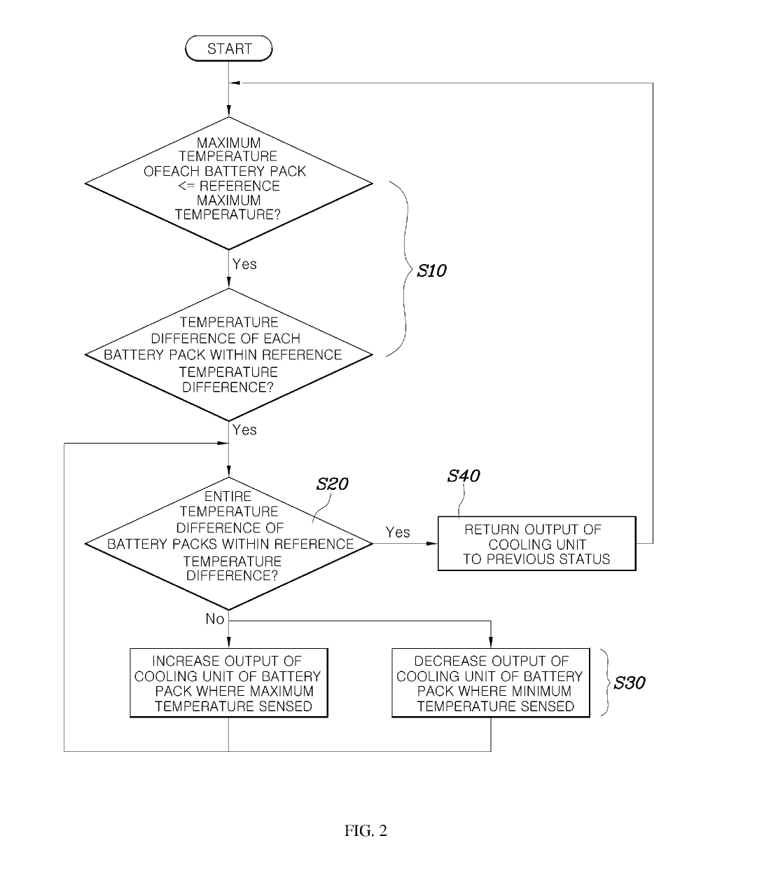

FIG. 2 illustrates an exemplary control process for cooling a battery system of a vehicle of the present invention which can be applied to the battery system illustrated in FIG. 1. This method as discussed above may be executed by one of the BMS 5, the BMS 7 or both, each of which are well understood in the art to include a processor for executing the method. More specifically, this method includes: a pack unit determining process (S10) that determines whether the respective maximum temperatures of a plurality of battery packs disposed in different locations are less than or equal to reference maximum temperatures and whether the temperature difference between battery cells in each of the battery packs is within a reference temperature difference value. Next, in response to the maximum temperature of the battery pack being less than or equal to the reference maximum temperature and the temperature difference between battery cells in each of the battery packs being within the reference temperature difference value, an entire difference determining process (S20) is performed that determines whether the temperature differences in all the battery packs are within the reference temperature difference. Subsequently, in response to determining that each of the temperature differences in all the battery packs is over the reference temperature difference value, executing a cooling control process (S30) that changes output of a cooling unit provided to cool the battery packs. That is, the maximum temperatures of the battery packs are controlled to be within the predetermined reference maximum temperature or less, and the temperature differences of the battery cells in the battery packs are controlled to be within the predetermined reference temperature difference. Therefore, the control process executed above prevents the battery packs from substantially exceeding the reference maximum temperature and the reference temperature difference of the battery packs because the control is performed for each battery pack on an individual basis rather than based on the temperature of the entire system as a whole. Therefore, in situations where the previous cooling system would universally control cooling to all of the battery packs in the system, the present invention utilizes a more individualized assessment by executing the entire difference determining step and removing heat from individual locations by the cooling control step (S30).

In the cooling control process (S30), it is possible to control the temperature difference of all the battery packs within the reference temperature difference by increasing the output of a cooling unit of a particular battery pack where the maximum temperature, which causes a temperature difference in all the battery packs, is detected. Further, in the cooling control process (S30), it may be possible to control the temperature difference of all the battery packs within the reference temperature difference by decreasing the output of a cooling unit of a battery pack where the minimum temperature, which causes a temperature difference in all the battery packs, is detected.

Additionally, the temperature difference can be more quickly converted within the reference temperature difference by using both of the methods, and in the embodiment illustrated in FIG. 1, the temperature difference can be quickly converged, by increasing, by either the BMS 5 or 7 or both, the output of a cooling unit of a battery pack at locations (i.e., packs) the maximum temperature, which causes a temperature difference in all the battery packs, is detected, and decreasing the output of a cooling unit of a battery pack at locations where the minimum temperature, which causes a temperature difference in all the battery packs, is detected.

In the battery system illustrated in FIG. 1, the battery packs are a master pack 1 and a slave pack 3, the cooling unit that cools the battery packs is a cooling fan, and the output is changed by increasing or decreasing the stage of the number of revolutions of the cooling fan in the cooling control process (S30). However, the cooling system is not limited to this exact configuration and may include any number of battery packs and any kind of cooling unit which may be controlled by a controller, such as a BMS.

On the other hand, once it is determined that the temperature difference of all the to battery packs as a result of continually repeating the entire difference determining process (S20) is within the reference temperature difference, a returning process (S40) is executed that returns the output of the cooling unit to the initial status may be performed.

The reference maximum temperature is a value set in advance through an experiment and analysis by the manufacture, as a temperature that should not be exceeded in consideration of deterioration of the battery packs, and the reference temperature difference is a value that is also set by determining a temperature range, where the battery cells should be, in advance through an experiment and analysis on the basis of the reference maximum temperature.

Advantageously, the present invention can minimize the number of times cell balancing occurs by appropriately controlling cooling of a battery system including battery packs mounted in different locations in a vehicle, improves performance and durability of a battery, and prevents deterioration of performance of the vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A control method of cooling a battery system for a vehicle, comprising:
determining, by a controller, whether the maximum temperatures of a plurality of battery packs disposed in different spaces are within the reference maximum temperature and whether the temperature differences of battery cells in each of the battery packs is within the reference temperature difference value;
in response to the maximum temperature of the battery pack being less than or equal to the reference maximum temperature and the temperature difference between battery cells in each of the battery packs being within the reference temperature difference value, determining, by the controller, whether the temperature differences in all the battery packs are within the reference temperature difference value; and
in response to determining that each of the temperature differences in all the battery packs is over the reference temperature difference value, changing an output of a cooling unit provided to cool each of the battery packs respectively.

2. The method of claim 1, wherein the output of a cooling unit of a battery pack is increased when the maximum temperature is detected which causes the temperature difference in all the battery packs cooled by that cooling unit to exceed the reference temperature difference.

3. The method of claim 1, wherein the output of a cooling unit of a battery pack is decreased when a minimum temperature, which causes the temperature difference in all the battery packs, is detected.

4. The method of claim 1, wherein the output of a cooling unit of a battery pack is increased when the maximum temperature is detected which causes the temperature difference in all the battery packs cooled by that cooling unit to exceed the reference temperature difference, and the output of a cooling unit of a battery pack is decreased when a minimum temperature, which causes the temperature difference in all the battery packs, is detected.

5. The method of claim 1, wherein the cooling unit that cools the battery packs is a cooling fan and the output is changed by increasing or decreasing a speed of the cooling fan.

6. The method of claim 1, further comprising:
repetitively determining, by the controller, whether the temperature differences in all the battery packs are within the reference temperature difference value in response until the temperature difference of all the battery packs are within the referenced temperature difference value; and
in response to determining that all of the battery packs are within the referenced temperature value, returning the output of the cooling unit to an initial status.

7. A controller for cooling a battery system for a vehicle, comprising:
a memory;
a processor configured to:
determine whether the maximum temperatures of a plurality of battery packs disposed in different spaces are within the reference maximum temperature and whether the temperature differences of battery cells in each of the battery packs is within the reference temperature difference value;
determine whether the temperature differences in all the battery packs are within the reference temperature difference value in response to the maximum temperature of the battery pack being less than or equal to the reference maximum temperature and the temperature difference between battery cells in each of the battery packs being within the reference temperature difference value; and
change an output of a cooling unit provided to cool each of the battery packs respectively in response to determining that each of the temperature differences in all the battery packs is over the reference temperature difference value.

8. The controller of claim 7, wherein the output of a cooling unit of a battery pack is increased when the maximum temperature is detected which causes the temperature difference in all the battery packs cooled by that cooling unit to exceed the reference temperature difference.

9. The controller of claim 7, wherein the output of a cooling unit of a battery pack is decreased when a minimum temperature, which causes the temperature difference in all the battery packs, is detected.

10. The controller of claim 7, wherein the output of a cooling unit of a battery pack is increased when the maximum temperature is detected which causes the temperature difference in all the battery packs cooled by that cooling unit to exceed the reference temperature difference, and the output of a cooling unit of a battery pack is decreased when a minimum temperature, which causes the temperature difference in all the battery packs, is detected.

11. The controller of claim 7, wherein the cooling unit that cools the battery packs is a cooling fan and the output is changed by increasing or decreasing a speed of the cooling fan.

12. The controller of claim 7, wherein the processor is further configured to:
repetitively determine whether the temperature differences in all the battery packs are within the reference temperature difference value in response until the temperature difference of all the battery packs are within the referenced temperature difference value; and
return the output of the cooling unit to an initial status in response to determining that all of the battery packs are within the referenced temperature value.

13. A non-transitory computer readable medium containing program instructions executed by a processor on a controller, the computer readable medium comprising:
program instructions that determine whether the maximum temperatures of a plurality of battery packs disposed in different spaces are within the reference maximum temperature and whether the temperature differences of battery cells in each of the battery packs is within the reference temperature difference value;
program instructions that determine whether the temperature differences in all the battery packs are within the reference temperature difference value in response to the maximum temperature of the battery pack being less than or equal to the reference maximum temperature and the temperature difference between battery cells in each of the battery packs being within the reference temperature difference value; and
program instructions that change an output of a cooling unit provided to cool each of the battery packs respectively in response to determining that each of the temperature differences in all the battery packs is over the reference temperature difference value.

14. The non-transitory computer readable medium of claim 13, wherein the output of a cooling unit of a battery pack is increased when the maximum temperature is detected which causes the temperature difference in all the battery packs cooled by that cooling unit to exceed the reference temperature difference.

15. The non-transitory computer readable medium of claim 13, wherein the output of a cooling unit of a battery pack is decreased when a minimum temperature, which causes the temperature difference in all the battery packs, is detected.

16. The non-transitory computer readable medium of claim 13, wherein the output of a cooling unit of a battery pack is increased when the maximum temperature is detected which causes the temperature difference in all the battery packs cooled by that cooling unit to exceed the reference temperature difference, and the output of a cooling unit of a battery pack is decreased when a minimum temperature, which causes the temperature difference in all the battery packs, is detected.

17. The non-transitory computer readable medium of claim 13, wherein the cooling unit that cools the battery packs is a cooling fan and the output is changed by increasing or decreasing a speed of the cooling fan.

18. The non-transitory computer readable medium of claim 13, further comprising
program instructions that repetitively determine whether the temperature differences in all the battery packs are within the reference temperature difference value in response until the temperature difference of all the battery packs are within the referenced temperature difference value; and
program instructions that return the output of the cooling unit to an initial status in response to determining that all of the battery packs are within the referenced temperature value.
